(19) United States
(12) Patent Application Publication
(10) Pub. No.: US 2012/0299749 A1
(43) Pub. Date: Nov. 29, 2012

(54) PARKING LOT MANAGEMENT SYSTEM

(75) Inventors: Hong Xiao, Acton, MA (US); Dongchen Wang, Concord, MA (US); Rahul Khushoo, Waltham, MA (US); Andre Turner, Belmont, MA (US); Afshin Moshrefi, Newburyport, MA (US)

(73) Assignee: VERIZON PATENT AND LICENSING INC., Basking Ridge, NJ (US)

(21) Appl. No.: 13/115,189

(22) Filed: May 25, 2011

(51) Int. Cl. G08G 1/14

(52) U.S. Cl. 340/932.2

(57) ABSTRACT

A parking lot management system determines a current parking space inventory for one or more parking lots using a parking database. The parking lot management system receives, via a network, a location associated with a parking customer, and identifies a parking lot of the one or more parking lots currently having available parking spaces based on the customer's location. The parking lot management system sends, via the network, at least one of a current occupancy, parking rates, or a location of the identified parking lot to the parking customer. The parking lot management system further receives a parking space reservation inquiry from the parking customer, and identifies a parking space from the identified parking lot based on the parking customer's location.

### BACKGROUND

Parking lots commonly exist at many different types of locations where large numbers of people may congregate, such as, for example, airports, commuter rail stations, shopping malls, exhibition halls, or universities. The parking lots may include outdoor parking lots, or indoor parking lots (e.g., underground, or in a parking garage). Parking at parking lots, particularly in a congested or urban setting, can be very inconvenient since the parking customer may be unaware of the current occupancy of a given parking lot, and may not be aware of the rates associated with one or more parking lots. The parking customer may not find out about a parking lot currently being full, or a high parking fee associated with a certain parking lot, until it is too late and the customer arrives at the parking lot in his/her automobile. Additionally, once parked in the parking lot, and when the customer attempts to return to the customer's automobile at a later time, the parking customer may have difficulty locating his/her automobile in the parking lot. Furthermore, many parking lots have controlled exit areas where departing customers must wait in potentially long lines to pay applicable parking fees.

### BRIEF DESCRIPTION OF THE DRAWINGS

FIG. 1 is a diagram that depicts an overview of the use of a parking lot management system to maintain a current parking space inventory for parking lots and to permit advance reservations of parking spaces at the parking lots;

FIG. 2 is a diagram that depicts an exemplary network environment in which the parking lot management system of FIG. 1 operates to maintain a current parking space inventory for parking lots, and permits advance reservations of parking spaces at the parking lots;

FIG. 3 is a diagram that depicts exemplary components of the parking lot management system of FIG. 1;

FIG. 4 is a diagram that depicts exemplary components of the automobile installed hand-held device of FIG. 2;

FIG. 5 is a diagram that depicts exemplary components of the parking lot system of FIG. 2;

FIG. 6A is a diagram that depicts an exemplary implementation of the parking lot system of FIG. 2 in which the automobile sensors include passive light sensors, or active infrared or RF sensors, disposed at each parking space;

FIG. 6B is a diagram that depicts an exemplary implementation in which the automobile sensors include still or video cameras disposed at locations within the parking lot to enable the automobile sensors to detect the presence of an automobile in each of the parking spaces of the parking lot;

FIGS. 7A and 7B are flow diagrams that illustrate an exemplary process for maintaining a current parking space inventory for parking lots and for enabling customers to reserve parking spaces in advance of arriving at a parking lot;

FIG. 8 is an exemplary messaging diagram associated with the process of FIGS. 7A and 7B;

FIG. 9 is a flow diagram that illustrates an exemplary process for inquiring, from a mobile device, about current occupancies and locations of parking lots and making advanced reservations of parking spaces at one of the parking lots;

FIG. 10 is a flow diagram that illustrates an exemplary process for obtaining the location of, and directions to, a parked automobile in one or more parking lots;

FIG. 11 is an exemplary messaging diagram associated with the process of FIG. 10;

FIG. 12 is a flow diagram that illustrates an exemplary process for controlling ingress and egress of automobiles to/from a parking lot, determining timestamps based on the ingress and egress of the automobiles, and charging parking customers associated with the automobiles based on the timestamps; and

FIG. 13 is an exemplary messaging diagram associated with the process of FIG. 12.

### DETAILED DESCRIPTION OF THE PREFERRED EMBODIMENTS

The following detailed description refers to the accompanying drawings. The same reference numbers in different drawings may identify the same or similar elements. The following detailed description does not limit the invention.

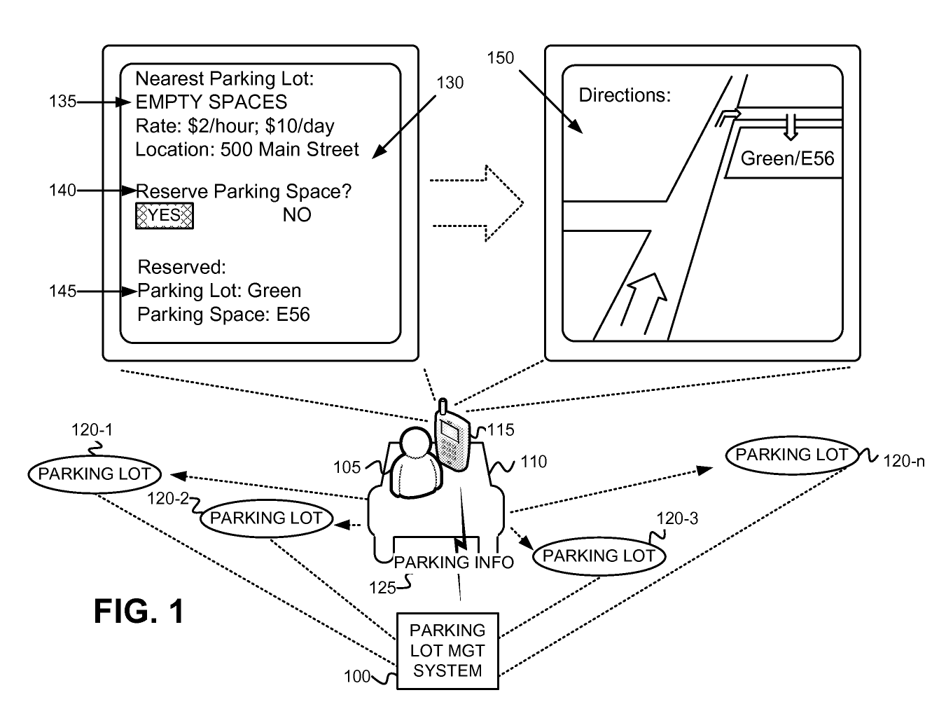

FIG. 1 is a diagram that depicts an overview of the use of a parking lot management system 100 to maintain a current parking space inventory for one or more parking lots and to permit advance reservations of parking spaces at the one or more parking lots. FIG. 1 depicts an example of a single parking customer 105 driving an automobile 110 that customer 105 wishes to park. Customer 105 may carry a mobile device 115, or mobile device 115 may be installed within automobile 110. Customer 105 and automobile 110 may be located within a certain proximity to one or more parking lots 120-1 through 120-n. Parking lot management system 100 may obtain a current location of mobile device 115 which also provides a current location of customer 105 and/or automobile 110. Based on the current location of mobile device 115, parking lot management system 100 may obtain and send parking information 125 to mobile device 115. As shown in mobile device display 130, parking information 125 may include nearest parking lot information 135 which further includes the current occupancy of a nearest parking lot to mobile device 115, parking rates of the nearest parking lot, and a location of the nearest parking lot. Mobile device display 130 may permit customer 105 to reserve 140 a parking space in the nearest parking lot, and may provide parking lot and parking space information 145 for the reserved parking space. As further shown in mobile device display 150, parking lot management system 100 may provide directions (e.g., textual directions and/or map directions) to the nearest parking lot where the reserved parking space is located.

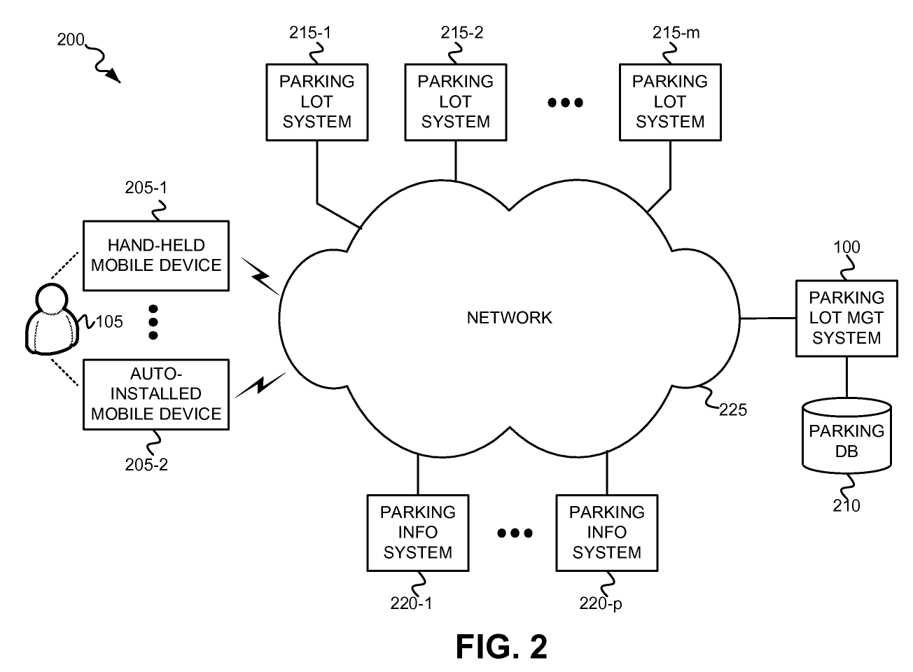

FIG. 2 is a diagram that depicts an exemplary network environment 200 in which parking lot management system 100 of FIG. 1 operates to maintain a current parking space inventory for one or more parking lots, and permits advance reservations of parking spaces at the one or more parking lots. Network environment 200 may include a hand-held mobile device 205-1 and an automobile installed mobile device 205-2 that each may be associated with customer 105 or with automobile 110 (not shown). Either of hand-held mobile device 205-1 or automobile installed mobile device 205-2 may correspond to mobile device 115 depicted in FIG. 1. As further shown in FIG. 2, network environment 200 may include parking lot management system 100, a parking database (DB) 210, parking lot systems 215-1 through 215-m, parking information systems 220-1 through 220-p, and network 225.

Hand-held mobile device 205-1 may include any type of digital computing device that has the capability to communicate via one or more wireless network connections (e.g., wireless cellular, BlueTooth wireless, “wi-fi,” etc.). Hand-held mobile device 205-1 may include, for example, a computer (e.g., a desktop, laptop, palmtop, or tablet computer), a cellular telephone (e.g., a smart phone), a personal digital assistant (PDA), a media player device, or a digital camera. Automobile installed mobile device 205-2 may include a digital computing device, installed within an automobile, that has the capability to communicate via one or more wireless network connections (e.g., wireless cellular, BlueTooth wireless, “wi-fi,” etc.). Automobile installed mobile device 205-2 may be specially designed for installation in a specific automobile (e.g., installed and mounted on automobile dashboard).

Parking lot management system 100 may include a network device that may maintain an accurate accounting of a current parking space inventory for one or more parking lots. Parking lot management system 100 may, based on customer inquiries via network 225, identify one or more parking lots currently having available parking spaces based on customer preferences, parking history data and/or a customer's current location. Parking lot management system 100 may additionally, based on customer reservation inquiries via network 225, identify a parking space to reserve from one or more parking lots based also on customer preferences, parking history data and/or a customer's current location. Parking lot management system 100 may store data received from parking lot systems 215-1 through 215-m identifying parking spaces used by given customers, and the parking ingress and/or egress times associated with the parking spaces.

Parking DB 210 may store the data maintained by parking lot management system 100. The data stored by parking DB 210 may, among other data, include a current parking space inventory for one or more parking lots, customer preferences, and parking history data. The current parking space inventory may include a detailed inventory of parking spaces, and their locations, and the occupancy status of each parking space (e.g., empty, reserved and/or occupied). Parking lot systems 215-1 through 215-m may maintain logs of automobiles entering and exiting respective parking lots, including storing ingress time stamps when a given automobile enters the parking lot and parks in a parking space, and egress time stamps when the given automobile exists the parking space and the parking lot. Parking lot systems 215-1 through 215-m may additionally calculate fees for each customer/automobile based on the ingress and egress time stamps, and may charge the calculated fee to each customer as his/her automobile exits a parking lot.

Parking information systems 220-1 through 220-p may enable customers to obtain information about a currently parked vehicle, including the automobile's location (e.g., parking lot and parking space) and directions to the automobile's location. Parking information systems 220-1 through 220-p may be placed in locations that are convenient to parking customers. For example, in the case of parking lots at an airport, a parking information system 220 may be placed at one or more locations in the airport terminal to enable parking customers to locate their parked automobiles, and to provide directions to those parked automobiles.

Network 225 may include one or more networks including, for example, a wireless public land mobile network (PLMN) (e.g., a Code Division Multiple Access (CDMA) 2000 PLMN, a Global System for Mobile Communications (GSM) PLMN, a Long Term Evolution (LTE) PLMN and/or other types of PLMNs), a telecommunications network (e.g., Public Switched Telephone Networks (PSTNs)), a local area network (LAN), a wide area network (WAN), a metropolitan area network (MAN), an intranet, the Internet, or a cable network (e.g., an optical cable network). Network 225 may enable mobile devices 205-1 and 205-2, parking lot systems 215-1 through 215-m, and parking information systems 220-1 through 220-p to communicate with parking lot management system 100.

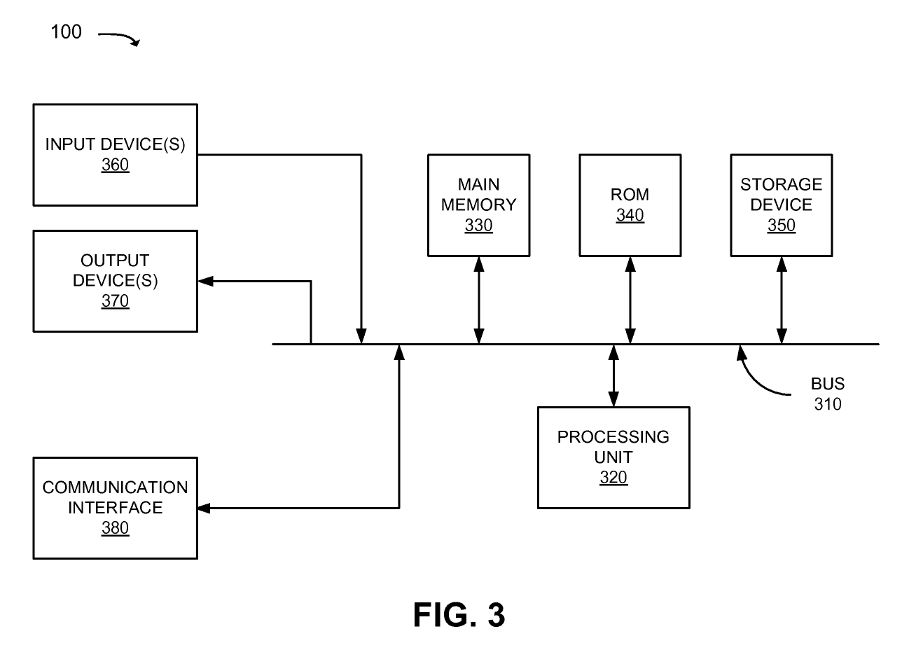

FIG. 3 is a diagram that depicts exemplary components of parking lot management system 100. Hand held mobile device 205-1, parking information system 220 and parking lot system 215 may be similarly configured.

Parking lot management system 100 may include a bus 310, a processing unit 320, a main memory 330, a read only memory (ROM) 340, a storage device 350, an input device(s) 360, an output device(s) 370, and a communication interface 380. Bus 310 may include a path that permits communication among the elements of parking lot management system 100.

Processing unit 320 may include one or more processors or microprocessors, or processing logic, which may interpret and execute instructions. Main memory 330 may include a random access memory (RAM) or another type of dynamic storage device that may store information and instructions for execution by processing unit 320. ROM 340 may include a ROM device or another type of static storage device that may store static information and instructions for use by processing unit 320. Storage device 350 may include a magnetic and/or optical recording medium.

Input device 360 may include one or more mechanisms that permit an operator to input information to parking lot management system 100, such as, for example, a keypad or a keyboard, voice recognition and/or biometric mechanisms, etc. Output device 370 may include one or more mechanisms that output information to the operator, including a display, a speaker, etc. Communication interface 380 may include any transceiver mechanism that enables parking lot management system 100 to communicate with other devices and/or systems. For example, communication interface 380 may communicate with mobile devices 205-1 and 205-2, parking lot systems 215-1 through 215-m and parking information systems 220-1 through 220-p via network 225.

The configuration of components of parking lot management system 100 illustrated in FIG. 3 is for illustrative purposes only. Other configurations may be implemented. Therefore, parking lot management system 100 (or hand held mobile device 205-1, parking information system 220, or parking lot system 215) may include additional, fewer and/or different components than those depicted in FIG. 3. For example, hand-held mobile device 205-1 may include a location determining component that may determine a geographic location of device 205-1 (e.g., a Global Positioning System (GPS) device).

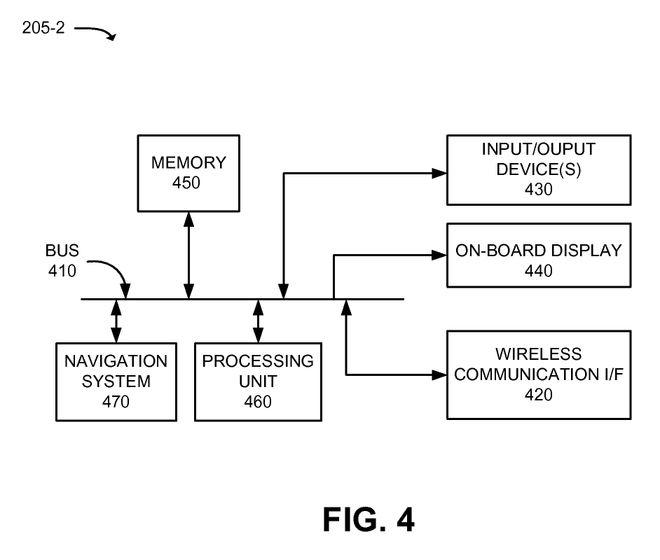

FIG. 4 is a diagram that depicts exemplary components of automobile installed hand-held device 205-2. Automobile installed hand held device 205-2 may include a bus 410, a wireless communication interface (I/F) 420, an input/output device(s) 430, an on-board display 440, a memory 450, a processing unit 460 and a navigation system 470.

Bus 410 may include a path that permits communication among the elements of mobile device 205-2. Wireless communication I/F 420 may include a transceiver unit for transmitting and receiving data via a wireless connection (e.g., to network 225). The transceiver unit of I/F 420 may include a cellular network radio frequency, or optical wireless, communication interface. Input/output device(s) 430 may permit an operator to input information to mobile device 205-2 or to output information from mobile device 205-2. For example, input/output device(s) 430 may include a keypad or a keyboard, voice recognition and/or biometric mechanisms, an audio speaker, etc. On-board display 440 may include a display, or a touch panel display, that may visually display images, video, data, and associated graphics, to customer 105. If display 440 includes a touch panel display, then display 440 may also operate as an input device for permitting customer 105 to input data (e.g., a parking inquiry or reservation inquiry) into mobile device 205-1. Memory 450 may include a random access memory (RAM), a read only memory (ROM), and/or another type of storage device that may store data and/or instructions for execution by processing unit 460. Memory 450 may further include a magnetic and/or optical recording medium and its corresponding drive. Processing unit 460 may include one or more processors or microprocessors, or processing logic, that may interpret and execute instructions (e.g., stored by memory 450). Navigation system 470 may include a system that permits mobile device 205-2 to provide navigation directions to customer 105 via on-board display 440. Navigation system 470 may include, for example, a Global Positioning System (GPS) device.

The configuration of components of automobile installed mobile device 205-2 illustrated in FIG. 4 is for illustrative purposes only. Other configurations may be implemented. Therefore, automobile installed mobile device 205-2 may include additional, fewer and/or different components than those depicted in FIG. 4.

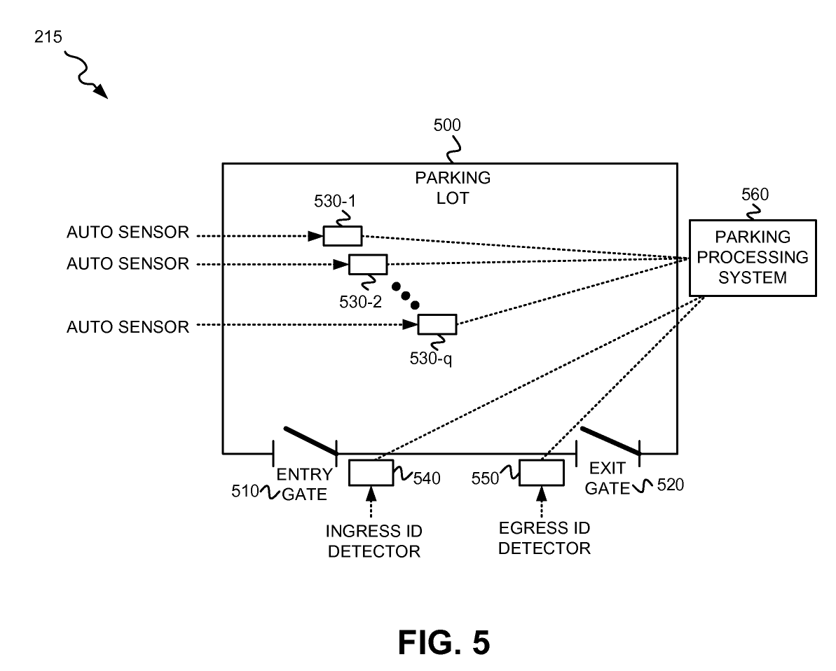

FIG. 5 is a diagram that depicts exemplary components of parking lot system 215. Parking lot system 215 may include components located in, or in the vicinity of, a parking lot 500. Parking lot 500 may include multiple parking spaces (not shown) in which automobiles may park, and may have an entry gate 510 and an exit gate 520 that controls entry and exiting of parking lot 500. Entry gate 510 may include physical mechanisms for selectively controlling entry into parking lot 500. Exit gate 520 may include physical mechanisms for selectively controlling exit from parking lot 500.

Parking lot system 215 may include one or more automobile sensors 530-1 through 530-q (where q is an integer greater than or equal to one), an ingress identification (ID) detector 540, an egress ID detector 550, and a parking processing system 560. Each of automobile sensors 530-1 through 530-q may include a passive light sensor that detects a change in ambient light when an automobile parks in a given parking space over the light sensor. Each of automobile sensors 530-1 through 530-q may alternatively include an active infrared or RF sensor, such as, for example, an infrared proximity sensor, that detects an automobile when it parks in a given parking space. Each of automobile sensors 530-1 through 530-q may alternatively include a still image or video camera that may generate still images or video of automobiles, parked in parking spaces in parking lot 500, that may be analyzed using image analysis techniques to identify parking spaces that are occupied and parking spaces that are empty.

Ingress ID detector 540 may be located at entry gate 510, and may detect the identity of mobile device 205, customer 105 or automobile 110 entering parking lot 500. Egress ID detector 550 may be located at exit gate 520 and may detect the identity of mobile device 205, customer 105 or automobile 110 exiting parking lot 500. Ingress ID detector 540 and egress ID detector 550 may include a still camera or video camera that may monitor the license plates of automobiles entering or exiting parking lot 500 to determine an ID of each automobile. Alternatively, ingress ID detector 540 and egress ID detector 550 may include a RF device that detects an ID of mobile device 205, customer 105 or automobile 110 for each automobile that enters or exits parking lot 500.

Parking processing system 560 may include a device that has one or more processors or microprocessors that may process and store data received from automobile sensors 530-1 through 530-q, entry gate 510, exit gate 520, ingress ID detector 540 and egress ID detector 550. Parking processing system 560 may additionally supply real-time data to parking lot management system 100 to enable system 100 to maintain a current parking space inventory of parking lot 500 (in conjunction with other parking lots processed by parking lot management system 100).

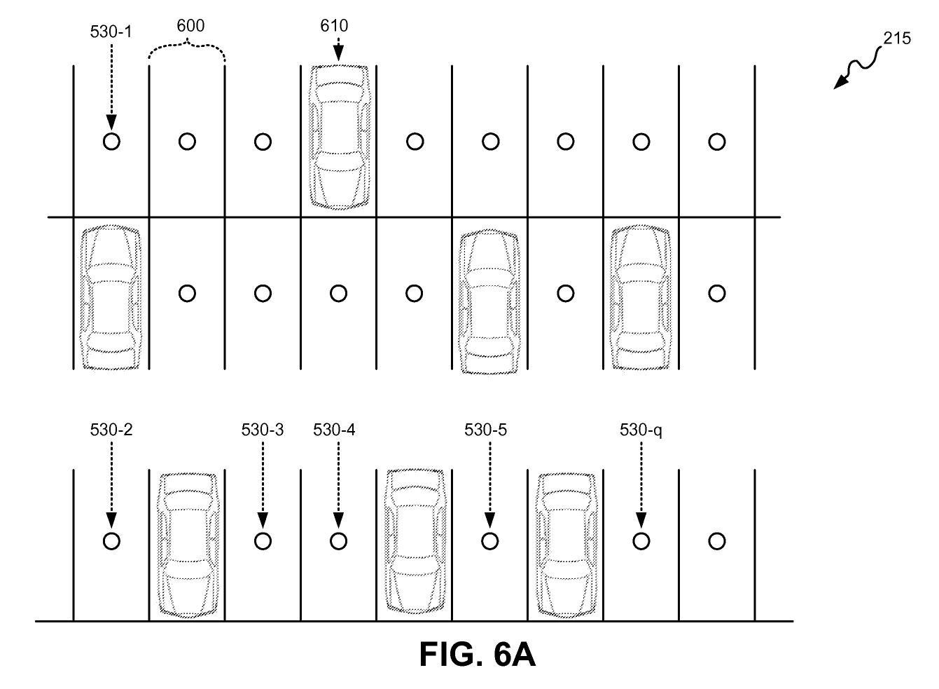

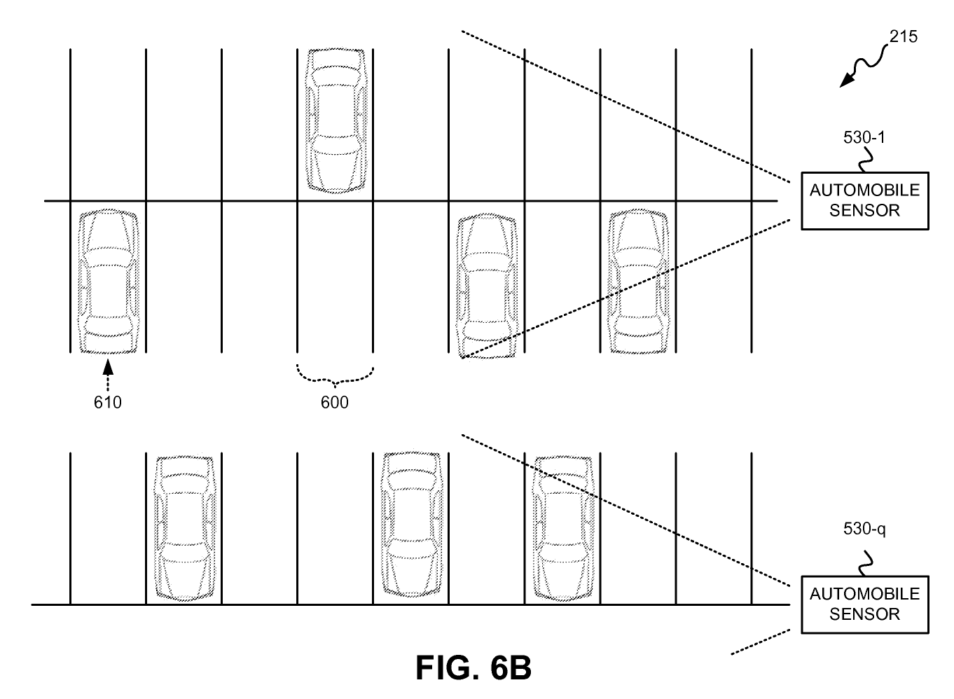

FIGS. 6A and 6B depict exemplary implementations of parking lot system 215 where the parking spaces of parking lot 500 (not shown in FIG. 5), are shown in relation to automobile sensors 530-1 through 530-q. FIG. 6A depicts an exemplary implementation in which automobile sensors 530-1 through 530-q include passive light sensors, or active infrared or RF sensors, disposed at each parking space. FIG. 6B depicts an exemplary implementation in which automobile sensors 530-1 through 530-q include still or video cameras disposed at locations within parking lot 500 to enable automobile sensors 530-1 through 530-q to detect the presence of an automobile in each of the parking spaces of parking lot 500.

In the exemplary implementation of FIG. 6A, automobile sensors 530-1 through 530-q include passive light sensors or active infrared or RF sensors and are disposed under the surface of each parking space 600. Therefore, when an automobile 610 parks in a given parking space 600, the corresponding automobile sensor 530 may detect that the parking space is occupied, and may send an appropriate signal to parking processing system 560 so that parking processing system 560 may update its parking space inventory. When automobile 610 exits the parking space, the corresponding automobile sensor 530 may detect that the parking space is empty, and may send an appropriate signal to parking processing system 560 so that parking processing system 560 may update its parking space inventory.

In the exemplary implementation of FIG. 6B, automobile sensors 530-1 through 530-q include still image or video cameras that are disposed at locations within the parking lot to enable the still image or video cameras to have an adequate view to detect the presence of automobiles in a given set of parking spaces of the parking lot. The images or video produced by the still image or video cameras may be analyzed using image processing techniques to detect the presence of automobiles in certain parking spaces within a given geographic region of the parking lot due to the limited viewpoint from the location of each still image or video camera. Therefore, more than one still image or video camera may be required to cover all of the parking spaces of a parking lot.

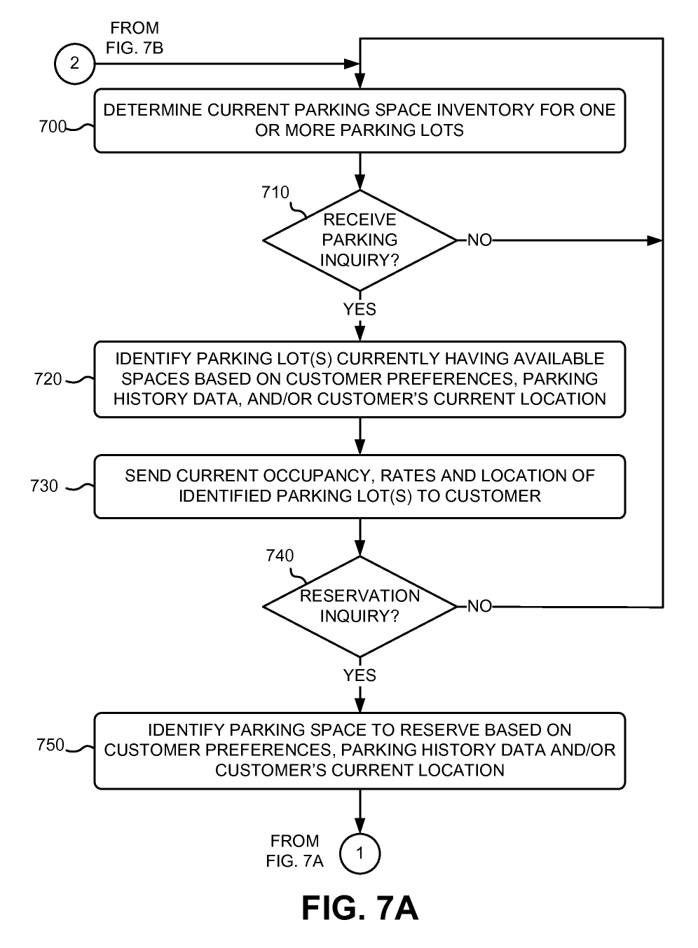

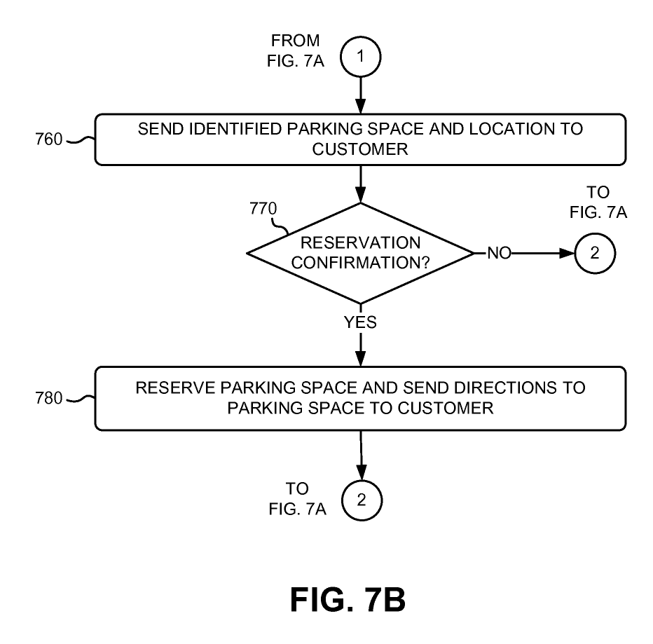

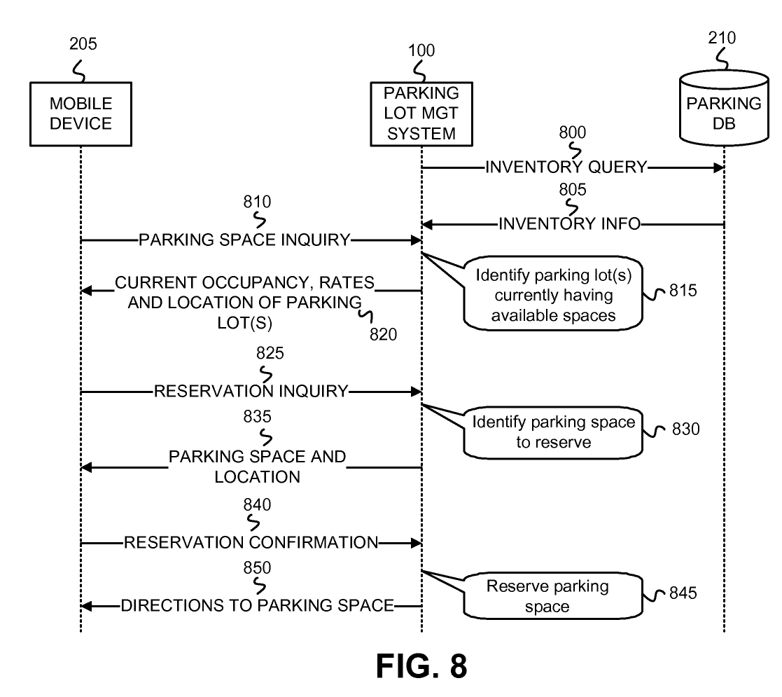

FIGS. 7A and 7B are flow diagrams that illustrate an exemplary process for maintaining a current parking space inventory for parking lots and for enabling customers to reserve parking spaces in advance of arriving at a parking lot. The exemplary process of FIGS. 7A and 7B may be implemented by parking lot management system 100. The exemplary process of FIGS. 7A and 7B is described below with reference to the messaging diagram of FIG. 8.

The exemplary process may include determining a current parking space inventory for one or more parking lots (block 700). Parking lot management system 100 may query parking DB 210 to determine the current inventory of empty parking spaces in the parking lot or parking lots. As shown in FIG. 8, parking lot management system 100 may send a parking inventory query message 800 to parking DB 210, and may receive an inventory information message 805 in response. Inventory information message 805 may include data related to the current location of parking spaces in one or more parking lots, the occupancy status of each parking space (e.g., empty, reserved, and/or occupied), and the current rates for the currently empty parking spaces.

Parking lot management system 100 may determine if a parking inquiry has been received from mobile device 205 (block 710). As depicted in FIG. 8, mobile device 205 may send a parking space inquiry 810 to parking lot management system 100. Parking space inquiry 810 may include a location of mobile device 205 and/or parking preferences of customer 105 associated with mobile device 205. If a parking inquiry has not been received at parking lot management system 100 (NO—block 710), then the exemplary process may return to block 700. If a parking inquiry has been received (YES—block 710), then a parking lot(s) currently having available parking spaces may be identified based on customer preferences, parking history data, and/or customer 105's current location (block 720). FIG. 8 shows parking lot management system 100 identifying 815 a parking lot(s) currently having available spaces. The customer preferences may have been explicitly identified by the customer at the time of the submission of the parking space inquiry, or may have been explicitly identified or provided previously by the customer (e.g., via a preference questionnaire). Additionally, the customer preferences may be inferred from previous parking lot usage of the customer. The parking history data may include data specifying historical parking lot usage of the customer, or other customers. For example, parking lot management 100 may identify a parking lot that has available spaces that is closest to the current location of mobile device 205. As another example, parking lot management system 100 may identify a parking lot, which has available spaces that is within a certain distance to the location of mobile device 205, and at which customer 105 has previously parked. As still another example, the customer may enter the name of a store or restaurant that he/she would like to visit and parking lot management system 100 may identify a parking space closest to that store or restaurant.

Parking lot management system 100 may send current occupancy information, parking rates and a location of the parking lot(s) identified in block 720 to customer 105 (block 730). From the current parking space inventory determined in block 700, parking lot management system 100 may determine the current occupancy of the identified parking lot(s) (e.g., how many parking spaces still available, or what percentage of parking spaces are still available), and the current parking rates that are applicable to currently empty parking spaces in the identified parking lot(s). FIG. 8 shows parking lot management system 100 sending a message 820 to mobile device 205 that includes a current occupancy status, parking rates, and the location of the identified parking lot(s).

Parking lot management system 100 may determine whether a reservation inquiry has been received (block 740). Based on the occupancy status, parking rates, and the location of the identified parking lot(s) of block 730, customer 105 using mobile device 205 may send a parking space reservation inquiry to parking lot management system 100. FIG. 8 depicts mobile device 205 sending a reservation inquiry message 825 to parking lot management system 100. If a reservation inquiry is not received from mobile device 205 (NO—block 740), then the exemplary process may return to block 700. If a reservation inquiry has been received (YES—block 740), then parking lot management system 100 may identify a parking space to reserve based on customer preferences, parking history data, and/or customer 105's current location (block 750). The customer preferences may have been explicitly identified by the customer at the time of the submission of the parking space inquiry or the reservation inquiry, or may have explicitly identified previously by the customer (e.g., via a preference questionnaire stored in the customer's profile). Additionally, the customer preferences may be inferred from previous parking lot usage of the customer. The parking history data may include data specifying historical parking lot usage of the customer, or other customers. For example, if the customer's preferences indicate that the customer prefers shopping at a specific store in a shopping mall, then a parking space in closest proximity to the specific store may be identified for reserving for the customer. FIG. 8 shows parking lot management system 100 identifying 830 a parking space to reserve.

Parking lot management system 100 may send the parking space identified in block 750) and its location to customer 105 (block 760). As shown in FIG. 8, parking lot management system 100 may send a message 835 that includes an identification of the parking lot and parking space, and the parking space's location (e.g., the geographic location of the parking lot, and the parking space's location within the parking lot). Parking lot management system 100 may determine whether a reservation confirmation has been received from customer 105 (block 770). As depicted in FIG. 8, mobile device 205, in response to receiving message 835 that includes the parking space identification information and location, may send a reservation confirmation message 840 to parking lot management system 100. If a reservation confirmation has not been received (NO—block 770), then the exemplary process may return to block 700. If a reservation confirmation has been received from customer 105, then parking lot management system 100 may reserve the parking space identified in block 750 and send directions to the parking space to customer 105 (block 780). FIG. 8 depicts parking lot management system 100 reserving 845 the previously identified parking space, and sending a message 850 to mobile device 205 that includes directions to the parking space. The exemplary process may continue at block 700.

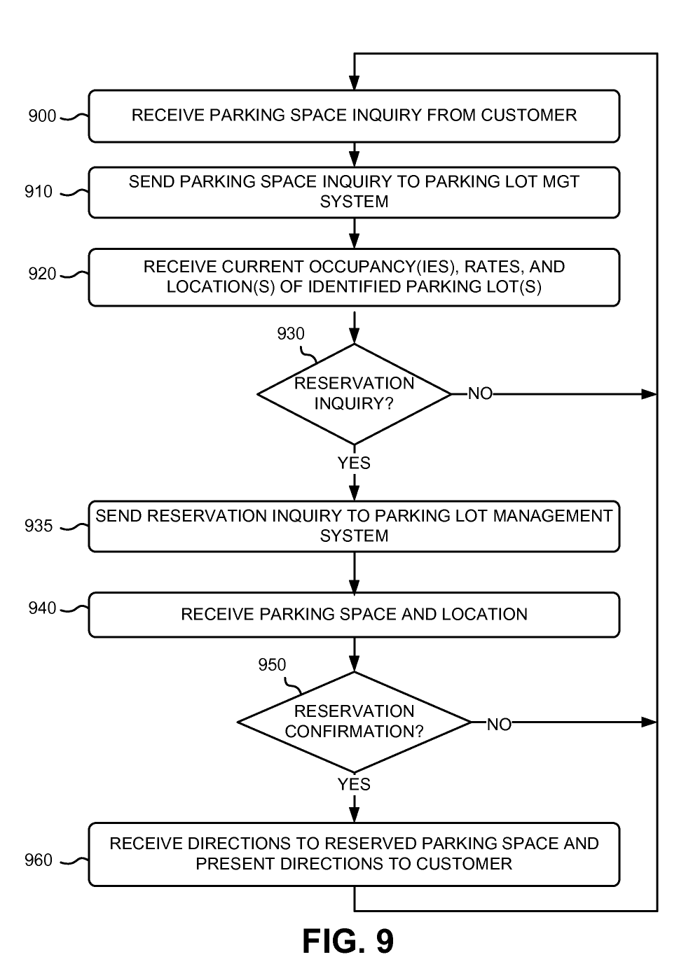

FIG. 9 is a flow diagram that illustrates an exemplary process for inquiring, from a mobile device, about current occupancies and locations of parking lots and making advanced reservations of parking spaces at one of the parking lots. The exemplary process of FIG. 9 may be implemented by hand-held mobile device 205-1 or automobile installed mobile device 205-2. The exemplary process of FIG. 9 is described below with reference to the messaging diagram of FIG. 8.

The exemplary process may include receiving a parking space inquiry from customer 105 (block 900). Customer 105 may enter, via input device 360 of hand-held mobile device 205-1 or input device 430 of automobile installed mobile device 205-2, an inquiry for parking. The inquiry may specify a particular parking lot location, or may specify a particular range from customer 105's current location (e.g., within 400 yards, within 1 mile, etc.). Mobile device 205 may send the parking space inquiry to parking lot management system 100 (block 910). The parking space inquiry may include, for example, a current location of mobile device 205 (e.g., obtained via GPS), and possibly parking preferences of customer 105. FIG. 8 depicts mobile device 205 sending a parking space inquiry message 810 to parking lot management system 100.

Mobile device 205 may receive the current occupancy(ies) and the location(s) of a parking lot(s) identified by parking lot management system 100 (block 920). As shown in FIG. 8, mobile device 205 may receive a message 820 from parking lot management system 100 that identifies the current occupancy(ies), rates and location(s) of the parking lot(s) identified by parking lot management system 100 in response to mobile device 205's parking space inquiry message 810.

Mobile device 205 may determine whether a reservation inquiry has been received (block 930). In response to receiving the current occupancy(ies), rates and location(s) of the identified parking lot(s), mobile device 205 may output the information to customer 105. Upon reviewing the information, customer 105 may enter, via input device 360 of hand-held mobile device 205-1 or input device 430 of automobile installed mobile device 205-2, his/her desire to reserve a parking space at the identified lot(s). The parking space reservation inquiry may include customer 205's parking space preferences. If a reservation inquiry has not been received (NO—block 930), then the exemplary process may continue at block 900. If a reservation inquiry has been received (YES—block 930), then mobile device 205 may send a reservation inquiry to parking lot management system 100 (block 935). FIG. 8 depicts mobile device sending a reservation inquiry message 825 to parking lot management system 100.

Mobile device 205 may receive an identification of the parking space and its location from parking lot management system 100 (block 940). As shown in FIG. 8, mobile device 205 may receive a message 835, which includes an identification of a reserved parking space and its location in a specified parking lot, from parking lot management system 100.

Mobile device 205 may determine whether a reservation confirmation has been received (block 950). Upon reviewing the parking space and location information, customer 105 may enter, via input device 360 of hand-held mobile device 205-1 or input device 430 of automobile installed mobile device 205-2, a confirmation of the reservation of the identified parking space. If a reservation confirmation has not been received (NO—block 950), then the exemplary process may return to block 900. If a reservation confirmation has been received (YES—block 950), then mobile device 205 may receive directions to the reserved parking space from parking lot management system 100, and may present the directions to customer 105 (block 960). FIG. 8 depicts mobile device 205 receiving a message 850 that includes directions to the reserved parking space. Hand-held mobile device 205-1 may present the directions to customer 105 via output device 370, or automobile installed mobile device 205-2 may present the directions to customer 105 via on-board display 440.

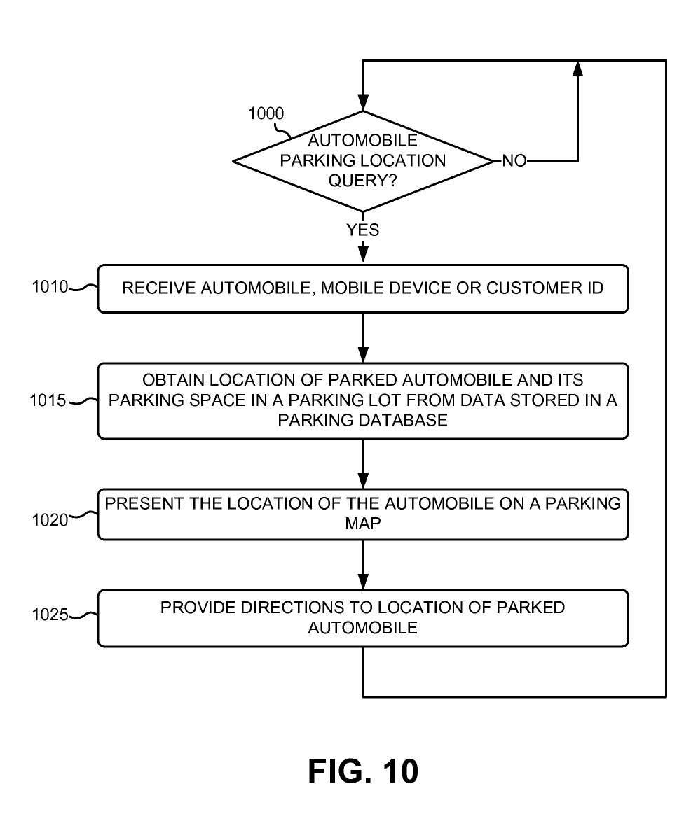

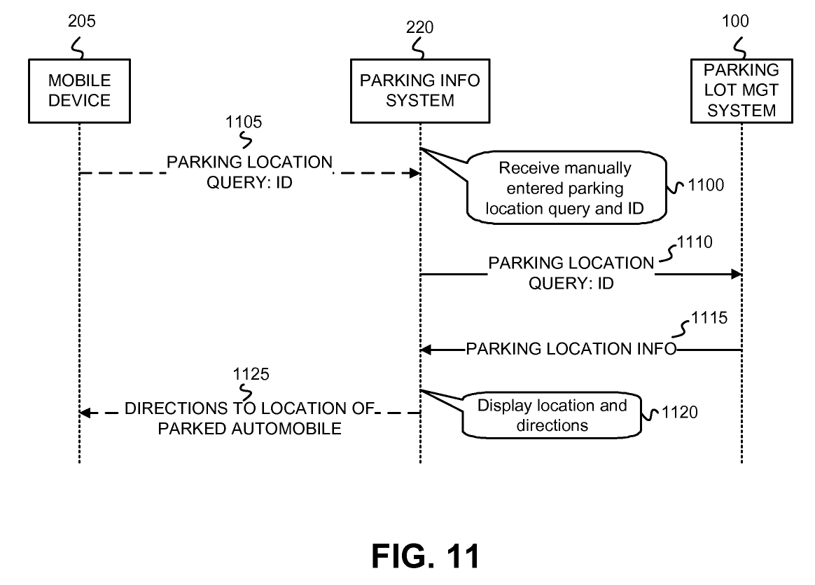

FIG. 10 is a flow diagram that illustrates an exemplary process for obtaining the location of, and directions to, a parked automobile in one or more parking lots. The exemplary process of FIG. 10 may be implemented by parking information system 220. The exemplary process of FIG. 10 is described below with reference to the messaging diagram of FIG. 11.

The exemplary process may include determining whether an automobile parking location query has been received (block 1000). Customer 105 may enter an automobile parking location query via input device 360 of parking information system 220. Alternatively, customer 105's hand-held mobile device 205-1 may send an automobile parking location query via a wireless connection (e.g., Bluetooth, or WiFi) to parking information system 220. If a parking location query has been received (YES—block 1000), then parking information system 220 may receive an automobile, mobile device or customer ID (block 1010). Customer 105 may enter the automobile, mobile device or customer ID via input device 360 of parking information system 220. Alternatively, customer 105's hand-held mobile device 205-1 may send the automobile, mobile device or customer ID via the wireless connection (e.g., Bluetooth, or WiFi) to parking information system 220. FIG. 11 depicts parking information system 220 receiving 1100 a manually entered parking location query and ID. FIG. 11 also shows an alternative in which mobile device 205 sends a message 1105 that includes a parking location query and ID.

Parking information system 220 may obtain a location of the parked automobile and its parking space in a parking lot from data stored in parking database 210 (block 1015). As shown in FIG. 11, parking information system 220 may send a message 1110 to parking lot management system 100 that includes the automobile, mobile device or customer ID received at parking information system 220. In response, parking lot management system 100 may index records stored in parking DB 210 with the automobile, mobile device or customer ID to retrieve a parking lot and parking space identification, and a parking lot location. Parking lot management system 100 may return a message 1115, which includes the parking lot and parking space identification, and the parking lot location, to parking information system 220.

Parking information system 220 may present the location of the automobile on a parking map (block 1020). Parking information system 220 may provide directions to the location of the parked automobile (block 1025). As shown in FIG. 11, parking information system 220 may display the parked automobile location, and may also display corresponding directions to the parked automobile location, on output device 370. In one exemplary implementation, output device 370 may include a touch screen display that may receive manual customer input, and may display parking map locations and directions. As also shown in FIG. 11, parking information system 220 may also send a message 1125, which includes directions to the location of the parked automobile, to mobile device 205 which, in turn, may display the parking location and directions to customer 105. In some implementations, mobile device 205 may provide voice directions, in addition to text-based directions, to the customer.

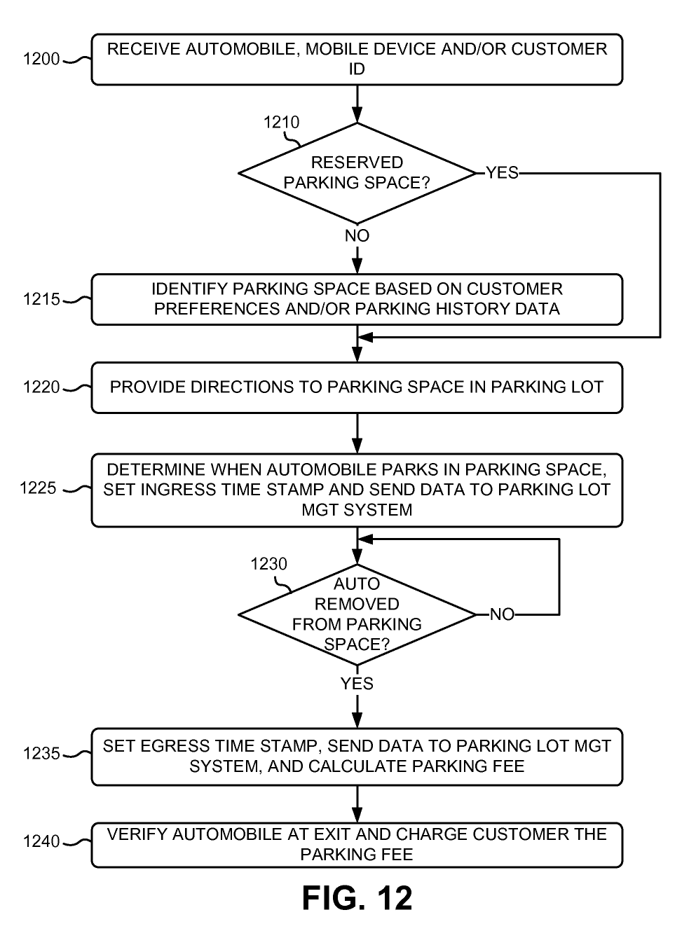

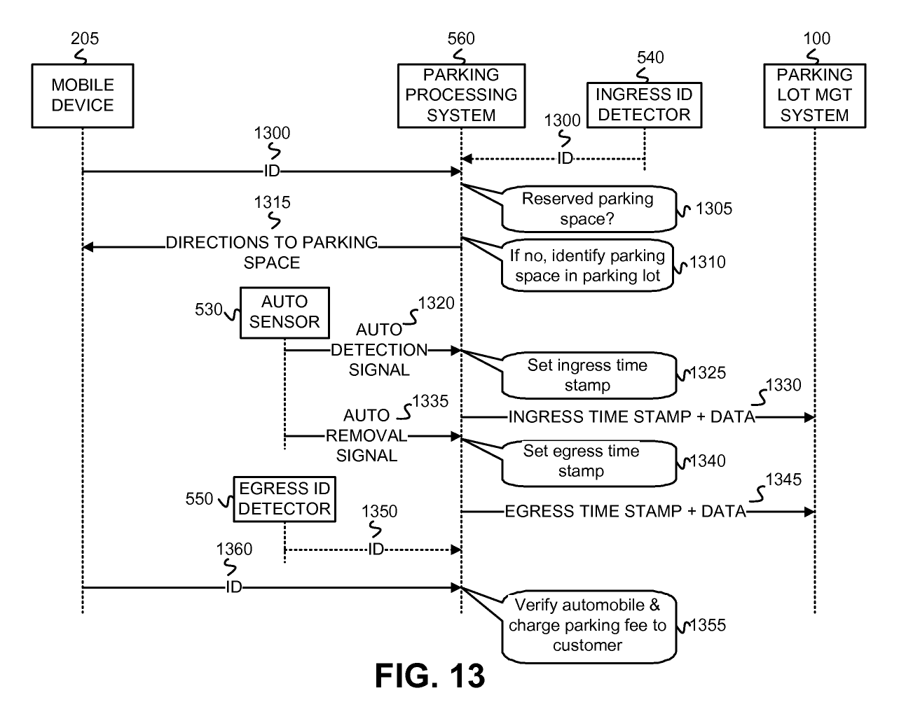

FIG. 12 is a flow diagram that illustrates an exemplary process for controlling ingress and egress of automobiles to/from a parking lot, determining timestamps based on the ingress and egress of the automobiles, and charging parking customers associated with the automobiles based on the timestamps. The exemplary process of FIG. 12 may be implemented by parking processing system 560 of parking lot system 215. The exemplary process of FIG. 12 is described below with reference to the messaging diagram of FIG. 13.

The exemplary process may include receiving an automobile, mobile device and/or customer identifier (block 1200). Ingress ID detector 540 of parking lot system 215 may identify an automobile, mobile device and/or customer ID. Ingress ID detector 540 may include a still camera or video camera that may monitor the license plate of an automobile attempting to enter the parking lot to determine an ID of the automobile. Alternatively, ingress ID detector 540 may include a RF device that detects an ID of mobile device 205, customer 105 or automobile 110 for each automobile that enters the parking lot. For example, as shown in FIG. 13, ingress ID detector 540 may send a message 1300 to parking processing system 560 that includes an ID of the automobile, mobile device and/or customer ID. Alternatively, as shown in FIG. 13, mobile device 205 may send a message 1300 to parking processing system 560 that includes an ID of the automobile, mobile device and/or customer.

Parking processing system 560 may determine whether there is a reserved parking space associated with the automobile, mobile device and/or customer identifier (block 1210). Parking processing system 560 may consult data stored at parking lot system 215, or in parking DB 210, to determine if a reserved parking space is associated with the automobile, mobile device, or customer ID. FIG. 13 depicts parking processing system 560 determining 1305 if there is a reserved parking space associated with the automobile, mobile device, or customer ID. If there is a reserved parking space (YES—block 1210), then the exemplary process may continue at block 1220. If there is no reserved parking space (NO—block 1210), then parking processing system 560 may identify a parking space based on customer preferences and/or parking history data (block 1215). Parking processing system 560 may use customer preferences and/or parking history data stored locally at parking lot system 215, or customer preferences and/or parking history data stored at parking DB 210. FIG. 13 depicts parking processing system 560 identifying 1310 a parking space in the parking lot.

Parking processing system 560 may provide directions to the parking space in the parking lot (block 1220). FIG. 13 shows parking processing system 560 sending a message 1315 to mobile device 205 that includes directions to the reserved or identified parking space. Parking processing system 560 may determine when the automobile parks in the parking space, may set the ingress time stamp, and send corresponding data to parking lot management system 100 (block 1225). As shown in FIG. 13, automobile sensor 530 may send an automobile detection signal 1320 to parking processing system 560 when sensor 530 detects the automobile parking in the identified or reserved parking space. Upon receipt of signal 1320, parking processing system 560 may set 1325 an ingress time stamp that identifies the time the car was parked in the parking space, and send a message 1330 that includes the ingress time stamp, and other data (e.g., automobile, mobile device or customer ID; parking lot and parking space identification; etc.).

Parking processing system 560 may determine if the automobile is removed from the parking space (block 1230). As shown in FIG. 13, parking processing system 560 may receive a signal 1335 from automobile sensor 530 indicating that the automobile has been removed from the parking space. If the automobile has been removed from the parking space (YES—block 1230), then parking processing system 560 may set an egress time stamp, send corresponding data to parking lot management system 100, and may calculate a parking fee (block 1235). FIG. 13 depicts parking processing system 560 setting 1340 an egress time stamp that indicates the time at which the automobile was removed from the parking space. Parking processing system 560 may then send a message 1345 that includes the egress time and other data (e.g., automobile, mobile device, or customer ID; parking lot and parking space identification; etc.) to parking lot management system 100.

Parking processing system 540 may verify the identity of the automobile at exit gate 520 of parking lot 500 and charge customer 105 the parking fee (block 1240). When the automobile approaches exit gate 520 of parking lot 500, egress ID detector 550 may identify the automobile, or the mobile device and/or customer ID associated with the automobile. Engress ID detector 550 may include a still camera or video camera that may monitor the license plate of an automobile attempting to exit the parking lot to determine an ID of the automobile. Alternatively, egress ID detector 550 may include a RF device that detects an ID of mobile device 205, customer 105 or automobile 110 for each automobile that exits the parking lot. For example, as shown in FIG. 13, egress ID detector 550 may send a message 1350 to parking processing system 560 that includes an ID of the automobile, mobile device and/or customer ID. Alternatively, as shown in FIG. 13, mobile device 205 may send a message 1360 to parking processing system 560 that includes an ID of the automobile, mobile device and/or customer. FIG. 13 further depicts parking processing system verifying 1355 the automobile at the exit gate, and charging the parking fee to the customer. Charging the parking fee to the customer may include charging the fee to a pre-established parking account, or to a credit or debit card owned by the customer.

The foregoing description of implementations provides illustration and description, but is not intended to be exhaustive or to limit the invention to the precise form disclosed. Modifications and variations are possible in light of the above teachings or may be acquired from practice of the invention. For example, while series of blocks have been described with respect to FIGS. 7A, 7B, 9, 10 and 12, the order of the blocks may be varied in other implementations. Moreover, non-dependent blocks may be performed in parallel. In some implementations, parking lot management system 100 may send advertisements and/or discount advertisements to customers when they are in proximity to a particular parking lot (e.g., ads indicating special parking fee rate for a certain parking lot for a customer).

Certain features described above may be implemented as “logic” or a “unit” that performs one or more functions. This logic or unit may include hardware, such as one or more processors, microprocessors, application specific integrated circuits, or field programmable gate arrays, software, or a combination of hardware and software.

No element, act, or instruction used in the description of the present application should be construed as critical or essential to the invention unless explicitly described as such. Also, as used herein, the article “a” is intended to include one or more items. Further, the phrase “based on” is intended to mean “based, at least in part, on” unless explicitly stated otherwise.

In the preceding specification, various preferred embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

What is claimed is:

1. A method, comprising:
determining a current parking space inventory for one or more parking lots using a parking database;
receiving, via a network, a location associated with a parking customer;
identifying a parking lot of the one or more parking lots currently having available parking spaces based on the customer's location; and
sending, via the network, at least one of a current occupancy, parking rates, or a location of the identified parking lot to the parking customer.

2. The method of claim 1, wherein the location comprises a geographic location of the parking customer obtained using a Global Positioning System (GPS).

3. The method of claim 1, further comprising:
receiving a parking space reservation inquiry from the parking customer;
identifying a parking space from the identified parking lot based on the customer's location; and
send the identified parking space and parking space's location to the parking customer.

4. The method of claim 3, further comprising:
receiving a reservation confirmation from the parking customer;
reserving the identified parking space; and
sending directions to the parking space to the parking customer.

5. The method of claim 1, wherein identifying the parking space from the identified parking lot is further based on preferences of the parking customer or parking history data.

6. The method of claim 1, wherein identifying the parking lot of the one or more parking lots currently having available parking spaces is further based on preferences of the parking customer or parking history data.

7. A network device, comprising:
a communication interface configured to receive a location associated with a parking customer; and
a processing unit configured to:
identify, based on a current parking space inventory, a parking lot of one or more parking lots currently having available parking spaces based on the customer's location, and
send, via the communication interface, at least one of a current occupancy, parking rates, a location of the identified parking lot, or a location of an available parking space to the parking customer.

8. The network device of claim 7, wherein the processing unit is further configured to:
determine a current parking space inventory for the one or more parking lots using a parking database.

9. The network device of claim 7, wherein the communication interface is further configured to receive a parking space reservation inquiry from the parking customer, and
wherein the processing unit is further configured to:
identify a parking space from the identified parking lot based on the parking customer's location, and
send at least one of the identified parking space or the parking space's location to the parking customer.

10. The network device of claim 9, wherein the communication interface is further configured to receive a reservation confirmation from the parking customer, and
wherein the processing unit is further configured to:
reserve the parking space, and
send, via the communication interface, directions to the parking space to the parking customer.

11. The network device of claim 7, wherein the location comprises a geographic location of the parking customer obtained using a Global Positioning System (GPS).

12. A method, comprising:
receiving an identifier associated with a parked automobile;
obtaining a location of the parked automobile and its parking space in a parking lot from data stored in a parking database; and
presenting the location of the parked automobile on a parking map.

13. The method of claim 12, further comprising:
providing directions to the location of the parked automobile.

14. The method of claim 13, wherein providing the directions comprises:
providing directions to the location of the parked automobile via the parking map.

15. The method of claim 12, wherein the identifier comprises an identifier of the automobile, an identifier of a customer associated with the automobile, or an identifier of a mobile device associated with the customer or the automobile.

16. The method of claim 12, wherein receiving the identifier associated with the parked automobile comprises:
receiving the identifier via manual entry at a parking information system.

17. The method of claim 15, wherein receiving the identifier associated with the parked automobile comprises:
receiving the identifier at a parking information system via communication with the mobile device.

18. The method of claim 17, wherein the communication with the mobile device comprises wireless communication between the mobile device and the parking information system.

19. A method, comprising:
determining, using an automobile sensor, when an automobile parks in a parking space in a parking lot;
setting an ingress timestamp when the automobile parks in the parking space; and
sending the ingress timestamp and data associated with the parked automobile for storage in a database.

20. The method of claim 19, wherein the automobile sensor comprises a passive light sensor, an active infrared or radiofrequency proximity sensor, or an image or video camera.

21. The method of claim 19, further comprising:
determining, using the automobile sensor, when the automobile is removed from the parking space;
setting an egress timestamp when the automobile is removed from the parking space;
charging a parking fee to a customer associated with the automobile based on the ingress and egress timestamps.

22. The method of claim 19, further comprising:
receiving an identifier associated with the automobile; and
identifying the parking space based on preferences of a customer associated with the automobile or based on parking history data.

23. The method of claim 22, further comprising:
providing directions to the parking space.
